(19) United States
(12) Patent Application Publication
(10) Pub. No.: US 2017/0136457 A1
(43) Pub. Date: May 18, 2017

(54) MICROFLUIDIC ELECTROKINETIC PAPER BASED DEVICES

(71) Applicant: TECHNION RESEARCH & DEVELOPMENT FOUNDATION LTD., Haifa (IL)

(72) Inventors: Moran BERCOVICI, Haifa (IL); Tally ROSENFELD, Haifa (IL)

(73) Assignee: Technion Research & Development Foundation Limited, Haifa (IL)

(21) Appl. No.: 15/319,836

(22) PCT Filed: Jun. 22, 2015
(86) PCT No.: PCT/IL2015/050632

§ 371 Date: Dec. 19, 2016

(30) Foreign Application Priority Data
Jun. 22, 2014 (GB) 1411094.4

(51) Int. Cl. B01L 3/00; G01N 27/447

(52) U.S. Cl. CPC B01L 3/50273; B01L 3/502715; B01L 3/502761; B01L 3/502707; G01N 27/44791; G01N 27/44765; B01L 2300/161; B01L 2300/165; B01L 2400/0421; B01L 2300/04; B01L 2300/0627; B01L 2200/12; B01L 2300/126

(57) ABSTRACT

A paper-based micro fluidic device suitable for electrokinetics and particularly isotachophoresis (ITP) and a kit comprising same is provided. Further, a method for the preparation of said paper-based micro fluidic device and a method of use thereof for the detection and/or separation of molecules of interest are provided.

### FIELD OF INVENTION

The present invention is directed to; inter alia, a paper-based micro fluidic device suitable for electrokinetic analysis and separation of molecules of interest.

### BACKGROUND OF THE INVENTION

Microfluidic paper-based analytical devices (μPADs) have recently gained significant attention, due to their potential as a low cost, durable, multiplexed, and easy-to-use diagnostic platform. μPADs are formed by patterning paper into hydrophilic regions, bounded by regions of hydrophobic material (Martinez et al., 2007, Angewandte Chemie International Edition, 46, 1318-1320). A variety of methods, including wax printing, CO₂ laser cutting, and photolithography now exist for fabrication of such devices (Yetisen et al., 2013, Lab Chip, 13, 2210-2251; Martinez et al., Anal. Chem., 2010, 82, 3-10), and they have found use in a variety of biochemical applications including glucose monitoring, detection of heavy metals, nanoparticle-based detection, total protein measurements, and ELISA. However, despite well identified biomarkers, many diagnostic needs cannot be met by the current sensitivity of such assays. The application of low-cost and rapid assays, capable of accurately and sensitively detecting disease at the point-of-care, could have a significant impact on global health, enabling access to advanced molecular diagnostics even in under-resourced and rural areas.

Microfluidic paper-based devices use paper as their substrate. “Paper” is a generalizing name given to membranes consisting of a two-dimensional network of fibers, usually cellulose, that admit fluids through their porous mesh by capillary action. While paper-based devices have the advantage of low-cost and simple fabrication, they inherently suffer from poor reproducibility due to the variations in local mesh topologies and densities. Thus, in a given time interval, fluid may travel significantly different distances in different paper channels.

Isotachophoresis (ITP) is an electrophoresis technique which allows for simultaneous separation and preconcentration of analytes based on their effective electrophoretic mobility. The process has been described repeatedly, as for instance, Bier and Allgyer, Electrokinetic Separation Methods 443-69 (Elsevier/North-Holland 1979). As illustrated in FIG. 1, ITP uses a discontinuous buffer system consisting of leading (LE) and terminating (TE) electrolytes. The LE and TE are chosen to have respectively higher and lower electrophoretic mobility than the analytes of interest. Sample is injected between the TE and LE (or can be mixed with the TE in the reservoir). When an electric field is applied, ions whose electrophoretic mobility is bracketed between that of the LE and TE focus within an electric field gradient at the LE-TE interface. Design of the LE and TE chemistries enables selective focusing of species of interest, and exclusion of undesired species.

Filter paper was used as substrate for electrophoresis before the introduction of gel electrophoresis or capillary-based electrophoresis. In the 70's and 80's, renewed interest in ITP lead to its first implementations on paper substrates including cellulose acetate membrane (CAM) and filter paper. ITP was used to directly focus or separate proteins of interest from urine, as well as to establish electroosmotic flow (EOF) patterns for delivery of target proteins to immunosensing sites. To mitigate excessive joule heating and evaporation, experimental setups either housed the membrane in a closed chamber, used external cooling components as part of their apparatus, or used cellogel film which holds a high water content in its gel matrix. In addition, experiments were run at relatively low electric fields, resulting in several hours of analysis time.

Other electrokinetic techniques have been demonstrated on paper substrates. Recently, Moghadam et al. (Anal. Chem., 2014) demonstrated ITP focusing on a nitrocellulose membrane housed in an acrylic device containing the reservoirs. The authors have addressed the challenge of evaporation by augmenting their main channel with a cross channel which is dipped in solution and provides additional hydration to the membrane.

While ITP is a very robust process, its initial conditions must be set up precisely. In particular, an interface between the LE and TE should be established, with minimum mixing between the two. In a microchannel implementation under laboratory conditions, this is typically established by first filling one of the East reservoir and the entire channel with LE, then filling the West reservoir with TE (see FIG. 1). In this way, the LE-TE interface is repeatedly formed at the exit of the West reservoir, and upon application of an electric field, electromigrates toward the LE reservoir. Notably, this approach is limited laboratory conditions and requires observing the paper filling process, and applying subsequent steps in proper timing.

There is a need for enhancing the sensitivity of paper-based devices, such as μPADs, while requiring minimum steps by an end user, and no additional equipment. Further, there is an unmet need for performing ITP on low-cost and massively producible substrates, which are also capable of processing large volumes of samples (e.g., hundreds of μL).

### SUMMARY OF THE INVENTION

The present invention provides, in some embodiments, a paper-based micro fluidic device suitable for electrokinetic analysis. In additional embodiments, there is provided a kit comprising said paper-based micro fluidic electrokinetic device, a method for its preparation and methods for detecting and/or separating molecules of interest.

The present invention is based, in part, on finding the properties required for introducing electrokinetic technique into paper-based micro fluidic devices (e.g., μPADs). As will be described in more detail hereinbelow, the device of the invention provides, in some embodiments, a barrier or a buffer zone establishing an interface between a two solutions (such as, LE and TE solutions in the case of ITP), while substantially preventing mixing of the two solutions until electro-kinetic initiation.

In additional embodiments, the device of the invention enables the use of high electric fields and short analysis time and is thus compatible for performing electrokinetic assays. In some embodiments, the flow channel(s) of the device of the invention have a depth of at most 100 μm. In some embodiments, the device includes flow channel(s) significantly shallower than an original thickness of a substrate (e.g., a paper substrate).

In one aspect, the present invention provides a micro-fluidic electrokinetic apparatus comprising a substrate comprising a porous hydrophilic region bounded by a fluid-impermeable barrier, said porous hydrophilic region comprises:
(a) a first zone configured to contain a first solution and a second zone configured to contain a second solution, said first zone and said second zone are configured to be operably connected to at least one anode and at least one cathode; and
(b) at least one flow channel elongated between said first zone and second zone, wherein a substantial portion of said at least one flow channel has a depth of at most 100 μm.

In some embodiments, said apparatus further comprises (c) at least one hydrophobic barrier disposed on said at least one flow channel and configured to define a contact region between a first solution and a second solution.

In some embodiments, said at least one hydrophobic barrier disposed on said at least one flow channel is configured to serve as an electrokinetic repeatable interface. In some embodiments, said at least one hydrophobic barrier disposed on said at least one flow channel comprises two hydrophobic barriers forming a sample injection zone configured to suspend fluidic flow until injection of a sample to said sample injection zone.

In some embodiments, said electrokinetic is isotachophoresis (ITP). In some embodiments, said first solution is a solution of high effective mobility leading electrolyte (LE) ion and said second solution is a solution of low effective mobility trailing electrolyte (TE) ion. In another embodiment, said hydrophobic barrier is an ITP starting point. In another embodiment, said at least one hydrophobic barrier is configured to permit ITP initiation after injection of said LE solution and TE solution to the respective first and second zones.

In some embodiments, said fluid-impermeable barrier substantially permeates the thickness of the substrate, thereby bounding said hydrophilic region therewithin.

In some embodiments, said substrate comprises at least one layer comprising said hydrophilic region and at least one hydrophobic layer. In another embodiment, said substrate is a dual layered substrate. In another embodiment, said at least one hydrophobic layer is disposed beneath and in contact with said at least one layer comprising said hydrophilic region.

In another embodiment, said porous hydrophilic substrate comprises at least one substance selected from the group consisting of: cellulose, cellulose acetate, nitrocellulose, polyester, glass or a combination thereof. In another embodiment, said porous hydrophilic substrate is chromatography paper, filter paper, blotting membrane, or lateral flow membrane.

In another embodiment, said apparatus further comprises a covering. In another embodiment, said covering is configured to be situated over a substantial portion of said at least one flow channel. In another embodiment, said covering has substantially low electrical conductivity. In another embodiment, said covering has substantially high thermal conductivity. In another embodiment, said covering is transparent. In another embodiment, covering is adhesive tape.

In another embodiment, the apparatus further comprises at least one probe configured to react with a molecule of interest. In another embodiment, said at least one probe is immobilized to a surface of said at least one flow channel. In another embodiment, said at least one probe is configured to provide a detectable signal upon reaction with a molecule of interest.

In another embodiment, said apparatus comprises a plurality of interconnected flow channels configured to separate a molecule of interest.

In another aspect, there is provided a method for detecting or separating a molecule of interest, comprising the steps of: (a) providing the micro-fluidic electrokinetic apparatus of the invention; (b) injecting to said apparatus a first solution, a second solution and a sample suspected of comprising a molecule of interest; (c) initiating electrokinetic flow; thereby detecting or separating the molecule of interest. In another embodiment, said initiating electrokinetic flow is automatically initiating electrokinetic flow by said injection step (b).

In another embodiment, said first solution is a solution of high effective mobility leading electrolyte (LE) ion, and said second solution is a solution of low effective mobility trailing electrolyte (TE) ion.

In some embodiments, said injection is finite injection. In another embodiment, said sample is mixed with injected independently (i.e., discretely) of the first solution and/or the second solution.

In another embodiment, said at least one hydrophobic barrier disposed on said at least one flow channel of said apparatus comprises two hydrophobic barriers forming a continuous sample injection zone. In another embodiment, said injection is to the sample injection zone. In another embodiment, said injection is continuous (infinite) injection.

In another embodiment, said sample is mixed with a first solution, such as LE. In another embodiment, said sample is mixed with a second solution, such as TE.

In some embodiment of the invention, the molecule of interest is selected from the group consisting of nucleic acids (including but not limited to DNA, RNA), peptides or polypeptides (including but not limited to (amino acid, protein, and antibody). In additional embodiments, the molecule of interest is a small chemical substance including but not limited to a heavy metal ion or a mixture of heavy metal ions.

In another aspect, there is provided a kit comprising: (i) the micro-fluidic electrokinetic apparatus of the invention; (ii) a first solution; and optionally (iii) a second solution. In some embodiments said kit is for detecting and/or selecting a molecule of interest.

In another embodiment, said first solution and second solution are a solution of high effective mobility leading electrolyte (LE) ion, and a solution of low effective mobility trailing electrolyte (TE) ion. In another embodiment, the LE and TE solutions have respectively higher and lower electrophoretic mobility than the molecule of interest.

In another embodiment, said kit further comprising instruction for use of said kit. In another embodiment, said kit further comprising a detector for detecting a molecule of interest.

In another aspect, there is provided a process for preparing a micro-fluidic electrokinetic apparatus, the method comprising:
(i) disposing a hydrophobic material onto a substrate in a predetermined pattern to define at least one hydrophilic region therewithin, said predetermined pattern comprising:
   (a) a first zone configured to contain a first solution and a second zone configured to contain a second solution;
   (b) at least one flow channel elongated between said first zone and second zone; and
   (c) at least one hydrophobic barrier disposed on said at least one flow channel;
(ii) heating the substrate and hydrophobic material disposed on said substrate to a temperature sufficient to melt the hydrophobic material, the melted hydrophobic material substantially permeating the thickness of said substrate and defining a pattern of at least one hydrophilic region.

In another embodiment, said flow channel has a depth of at most 100 μm.

In another embodiment, said process further comprises disposing a layer of a second hydrophobic material on an opposite side of said substrate, wherein said heating of step (c) is sufficient to melt the second hydrophobic material to substantially permeate the thickness of said substrate. In another embodiment, said hydrophobic material and said layer of second hydrophobic material form a hydrophilic region comprising at least one flow channel having a depth of at most 100 μm.

In another embodiment, said heating is in the range of 60° C.-120° C. In another embodiment, said heating is in the range of 75° C.-105° C.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1. Schematic illustration of a typical ITP assay. A simple microchannel is connected to two reservoirs and is initially filled with LE solution. Analytes are mixed in the trailing electrolyte (TE) reservoir. When an electric field is applied all ions electromigrate in the channel. The LE and TE are chosen such that analytes of interest have a higher mobility than the TE, but cannot overspeed the LE. This results in selective focusing at the sharp LE-TE interface.

FIG. 2. Schematic illustration of a non-limiting example of a multistep fabrication process.

FIG. 3. A non-limiting example of a fabricated paper-microfluidic device. The printed hydrophobic (wax) barrier serves as a repeatable starting point for ITP.

FIGS. 4a-f. Demonstration of the use of a μPAD fabricated by a non-limiting example for ITP focusing. (4a) Electrodes are placed in each of the reservoirs, and LE is added to the right reservoir (4b) The channel is filled with the LE buffer by capillary action (4c) After ˜15 min, when the LE front stops at the barrier, TE-sample mixture is added to the left reservoir (4d) Contact is formed between the TE and LE buffers, and ITP automatically initiates. (4e) Raw fluorescence image of ITP focusing of 1 μM fluorescein on a filter paper, imaged by a consumer-grade camera (4f) Typical fluorescence image of ITP focusing imaged under a microscope. The device's length, end-to-end, is ˜5 cm.

FIGS. 5a-c. Experimental measurements of focusing ratio achieved in paper ITP (5a) Raw fluorescence image of the focusing zone. The analyte's maximum concentration is denoted by “Cpeak”. (5b) The area averaged fluorescence intensity of the analyte was calculate, and denote δ(t) as the full width of the profile at 10% of the maximum value. The average concentration in that region is denoted as “Caverage”. (5c) Measurements of Cpeak, and Caverage, based on 4 repeats. Results show that paper-based ITP provides average concentration enhancement of 300-fold, while the peak concentration is increased by 1,500-fold.

FIGS. 6a-c. Experimental results showing continuous ITP focusing of a fluorescent dye in a filter paper channel (grade 595, Whatman, GE). 10 nM DyLight650 was injected into the TE, and fluorescence intensities was measured during ITP, at fixed distances from the TE reservoir. (6a) Area averaged fluorescence intensity profiles registered at each position. (6b) Total accumulated sample at each station (above a 10% of the peak value threshold). Results show that sample accumulation rate is consistent with ITP theory for constant voltage (6c) Raw intensity images corresponding to each position. LE is 100 mM HCl and 200 mM BisTris; TE is 10 mM Tricine and 20 mM BisTris. For both buffers 1% of polyvinylpyrrolidone (PVP) was used.

FIG. 7. Schematic representation of a non-limiting example of heat transfer using paper-based electrokinetcs. Region A represents the paper channel, occupied by the liquid, and region B represents the sealing material (i.e. tape). The bottom hydrophobic layer is assumed to be perfectly insulating. Heat is generated in region A, dissipates through the tape and is removed by free convection in air.

FIGS. 8a-c. Experimental characterization of ITP focusing on paper. (8a) Experimental results for paper and glass showing the efficiency parameter η (ratio of total accumulated sample to the integral of current and initial sample concentration), registered at each station. The horizontal black dashed lines represent the mean value of η. (8b) Experimental results showing that the reducing in mobility and total concentration of the TE (from 100 mM Hepes, 200 mM BisTris to 10 mM Tricine, 20 mM BisTris) results in a 34-fold improvement in the focusing rate. (8c) The total accumulated sample in moles, as a function of time, registered at each station, obtained for the Tricine-based experiments. The trend lines represent the theoretical solutions, based on the evaluation of η.

FIG. 9. Schematic representation of a non-limiting example of a device of the invention having a dual barrier as a sample injection site.

FIGS. 10a-b: Demonstration of ITP focusing of HRP-2 on paper (10b) and in a glass (10a) microchannel.

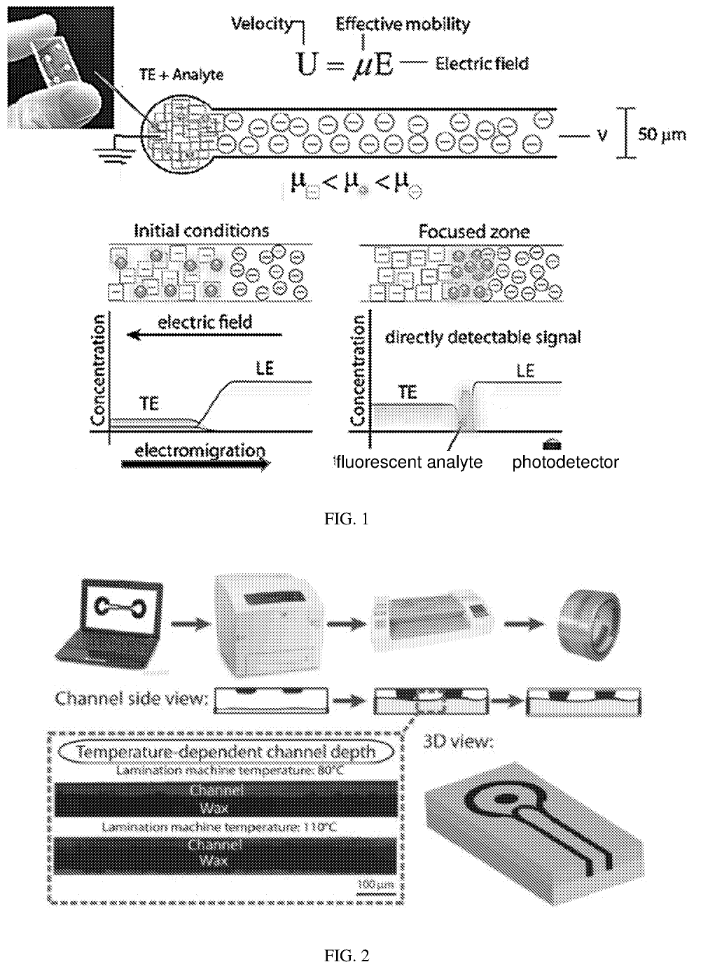

### DETAILED DESCRIPTION OF THE INVENTION

The present invention provides, in some embodiments, a paper-based micro fluidic device suitable for electrokinetic analysis. In additional embodiments, there is provided a kit comprising said paper-based micro fluidic electrokinetic device, a method for its preparation and methods for detecting and/or separating molecules of interest.

In some embodiments, the device and method disclosed herein enables processing large volumes of samples. (e.g., hundreds of μL) in short period of time (relative to the time required using other alternatives such as low current). As a non-limiting example, the invention demonstrates hereinbelow over 1,000-fold focusing of 30 μL of sample in 10 min.

The present invention is based in part on the finding that addition of a hydrophobic barrier disposed on a flow channel(s) establishes an accurate initial interface location between the two solutions (such as, LE and TE solutions in the case of ITP).

In embodiments wherein said electrokinetic is ITP, said initial interface location refers to the physical location in space where the LE and TE solutions come in contact.

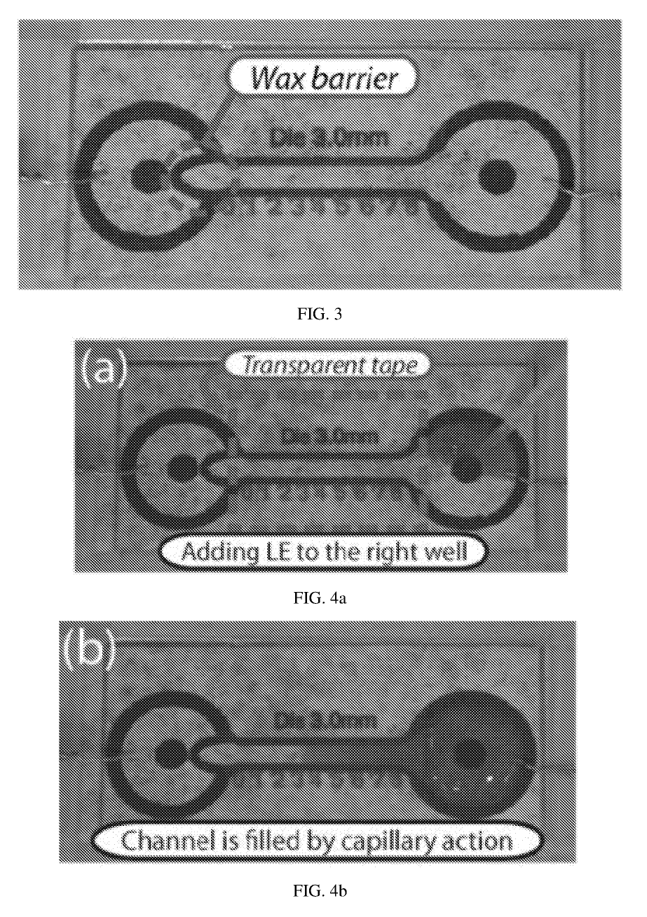

In another embodiment, said at least one hydrophobic barrier is configured to suspend fluidic flow until injection of a first and a second solution to the respective first and second zones. In another embodiment, said at least one hydrophobic barrier is configured to permit fluidic flow after injection of a first and a second solution to the respective first and second zones. A non-limiting example of a simplified flow channel comprising a hydrophobic barrier is illustrated in FIG. 3.

In some embodiments, said at least one hydrophobic barrier disposed on said at least one flow channel comprises two hydrophobic barriers forming a sample injection zone configured to suspend fluidic flow until injection of a sample to said sample injection zone. A non-limiting example of a simplified flow channel comprising a dual hydrophobic barrier is illustrated in FIG. 9.

The present invention is further based in part on the finding of a unique fabrication process and properties enabling overcoming joule-heating. In some embodiments of the invention, the flow channel(s) within the device have a depth of at most 150 μm, at most 125 μm, at most 100 μm, at most 90 μm, at most 80 μm, at most 70 μm, at most 60 μm or at most 50 μm, wherein each possibility represents a separate embodiment. In some embodiments, said depth of the flow channel(s) results in sufficiently rapid heat dissipation from the device. Thus, the device of the invention enables the use of high electric fields and short analysis time and is compatible for performing electrokinetic assays.

The present invention provides, in some embodiments, electrokinetic analysis including but not limited to isotachophoresis focusing on μPAD, which do not require any specialized enclosures or cooling devices. In additional embodiments, the device and methods disclosed herein do not require augmenting a main channel, such as with a cross channel dipped in solution to provide additional hydration to the membrane

In some embodiments, the present invention provides a micro-fluidic electrokinetic apparatus comprising a substrate comprising a porous hydrophilic region bounded by a fluid-impermeable barrier, said porous hydrophilic region comprises (a) a first zone configured to contain a first solution and a second zone configured to contain a second solution, said first zone and said second zone are configured to be operably connected to at least one anode and at least one cathode; (b) at least one flow channel elongated between said first zone and second zone, wherein a substantial portion of said at least one flow channel has a depth of at most 100 μm; and (c) at least one hydrophobic barrier disposed on said at least one flow channel and configured to define a contact region between a first solution and a second solution.

In another aspect, there is provided a system comprising said micro-fluidic electrokinetic apparatus. In some embodiments, the system comprises the micro-fluidic electrokinetic apparatus disclosed herein and at least one anode and at least one cathode. In one embodiment, the electrode in each of the reservoirs is embedded in the substrate. In another embodiment, the electrode in each of the reservoirs is external to the substrate. Typically, two or more electrodes could be used, such as in the case of channel networks.

In some embodiments, the system comprises the micro-fluidic electrokinetic apparatus disclosed herein and a control unit configured to modulate an ITP interface of said ITP apparatus in response to a significant electric current or voltage change (such as due to a constriction of the flow channel).

In some embodiments, the system comprises the micro-fluidic electrokinetic apparatus disclosed herein and a detector. In some embodiments, the detector is configured to detect a molecule of interest.

A skilled artisan will appreciate that the apparatus and method of the invention may apply constant voltage and detect current changes, or vice versa, apply constant current and detect voltage changes.

The flow channel of said device may be substantially straight. In other embodiments, the flow channel has geometric variations such as expansions or constrictions. Networks of independent or connected channels could also be fabricated and used. In additional embodiments, the channel has a varying (non-uniform) depth, as long as it substantial portion of the channel has a depth of at most 100 μm, at most 75 μm or at most 50 μm.

In some embodiments, the electroosmotic flow in the paper is used to hold the ITP front stationary and obtain longer focusing and/or reaction times.

In some embodiments, the slow diffusion rate in paper is used to obtain longer focusing and/or reaction times, after stopping the ITP front at a desired location.

### Use of the Device of the Invention

In another embodiment, there is provided a method for detecting or separating a molecule of interest, comprising the steps of: (a) providing the micro-fluidic electrokinetic apparatus of the invention; (b) injecting to said apparatus a first solution, a second solution and a sample suspected of comprising a molecule of interest; (c) initiating electrokinetic flow; thereby detecting or separating the molecule of interest. In another embodiment, said initiating electrokinetic flow is automatically initiating electrokinetic flow by said injection of step (b).

In another embodiment, said electrokinetic is ITP, said first solution is a solution of high effective mobility LE ion, and said second solution is a solution of low effective mobility TE ion.

In some embodiments, said method is suitable for finite injection. In another embodiment, there is provided a method for detecting or separating a molecule of interest, comprising the steps of: (a) providing the apparatus of the invention; providing to said first zone a solution of high effective mobility LE ion; (b) providing to said second zone a composition comprising a solution of low effective mobility TE ion and a sample suspected of comprising a molecule of interest; (c) initiating ITP by automatically or manually closing a circuit between said at least one anode and at least one cathode; thereby detecting or separating the molecule of interest.

In another embodiment, said method is suitable for continuous (infinite) injection. In another embodiment, there is provided a method for detecting or separating a molecule of interest, comprising the steps of: (a) providing the micro fluidic ITP apparatus of the invention, said apparatus comprising a solution of high effective mobility LE ion applied to said first zone, and a solution of low effective mobility TE ion applied to said second zone; (b) providing a sample suspected of comprising a molecule of interest to the intermediate zone of flow channel of said apparatus; (c) initiating ITP by automatically or manually closing a circuit between said at least one anode and at least one cathode; thereby detecting or separating the molecule of interest.

In some embodiments, the device is useful for extraction of nucleic acid (e.g., DNA, RNA) or amino acid (e.g. peptide, proteins) from relatively large volumes of liquid (hundreds of microliters). In some embodiments, the device is useful for chemical toxin detection in water.

In another embodiment, the micro-fluidic electrokinetic device is for diagnostic use. None limiting examples of diagnostic use include detection of pathogens such as in bodily fluids, water and food. None limiting examples of biomarkers include nucleic acids (e.g. 16S rRNA as a marker for bacteria); proteins (e.g. HRPII as a marker for Malaria plasmodium falciparum), depending on the mature of the analyte.

In another embodiment, the method described herein is used for detecting a disease or disorder in a subject (e.g., a mammal and particularly human subject). It will be apparent to one skilled in the art than many disease-specific biomarkers (e.g., human miRNA) are known and can be used in the methods described herein. None limiting examples include prostate-specific membrane antigen (PSMA) for detection of prostate cancer and cTnI (cardiac trophonin I) for detection of cardiac damage. In another embodiment, the method described herein is used for detection of antibiotic resistance (e.g., by determining bacterial DNA). In another embodiment, the method described herein is used for detection of specific bacterial strains (e.g., by determining bacterial DNA).

In another embodiment, said molecule or analyte of interest is selected from nucleic acid molecules or amino acid molecules, including peptides and proteins. In additional embodiments, the molecule of interest is a marker or biomarker indicative of a subject's health (e.g., immune state or cancerous state). In another embodiment, said molecule or analyte of interest is a bacteria or a virus.

In another embodiment, said device and method described herein is useful for laboratory assays, including but not limited to ELISA and microarray chips.

In another embodiment, the term “detecting” includes labeling, separating, enriching, identifying, sorting, isolating, or any combination thereof. In another embodiment, detecting is quantitative, qualitative, or both.

In another embodiment, the apparatus further comprises at least one probe configured to react with a molecule of interest. In another embodiment, said at least one probe is immobilized to a surface of said at least one flow channel. In another embodiment, said at least one probe is configured to provide a detectable signal upon reaction with a molecule of interest. In some embodiments, said probe is selected from a DNA probe, RNA probe, LNA probe, BNA probe, PNA probe, antibody probe, molecular beacon probe, aptamer probe, antigen probe. Selection of suitable probes is well under the capability of a skilled artisan.

In some embodiment of the invention, the molecule of interest is a chemical substance. In some embodiments, the chemical substance is a pollutant. A non limited group of chemical substances (currently known as priority pollutant and listed in http ://water.epa.gov/scitech/methods/cwa/pollutants.cfm) includes Acenaphthene, Acrolein, Acrylonitrile, Benzene, Benzidine, Carbon tetrachloride (tetrachloromethane), Chlorobenzene, 1,2,4-trichlorobenzene, Hexachlorobenzene, 1,2-dichloroethane, 1,1,1-trichloreothane, Hexachloroethane, 1,1-dichloroethane, 1,1,2-trichloroethane, 1,1,2,2-tetrachloroethane, Chloroethane, Bis(2-chloroethyl) ether, 2-chloroethyl vinyl ether (mixed), 2-chloronaphthalene, 2,4, 6-trichlorophenol, Parachlorometa cresol, Chloroform (trichloromethane), 2-chlorophenol, 1,2-dichlorobenzene, 1,3-dichlorobenzene, 1,4-dichlorobenzene, 3,3-dichlorobenzidine, 1,1-dichloroethylene, 1,2-trans-dichloroethylene, 2,4-dichlorophenol, 1,2-dichloropropane, 1,2-dichloropropylene (1,3-dichloropropene), 2,4-dimethylphenol, 2,4-dinitrotoluene, 2,6-dinitrotoluene, 1,2-diphenylhydrazine, Ethylbenzene, Fluoranthene, 4-chlorophenyl phenyl ether, 4-bromophenyl phenyl ether, Bis(2-chloroisopropyl) ether, Bis(2-chloroethoxy) methane, Methylene chloride (dichloromethane), Methyl chloride (dichloromethane), Methyl bromide (bromomethane), Bromoform (tribromomethane), Dichlorobromomethane, Chlorodibromomethane, Hexachlorobutadiene, Hex achloromyclopentadiene, Isophorone, Naphthalene, Nitrobenzene, 2-nitrophenol, 4-nitrophenol, 2,4-dinitrophenol, 4,6-dinitro-o-cresol, N-nitrosodimethylamine, N-nitrosodiphenylamine, N-nitrosodi-n-propylamin, Pentachlorophenol, Phenol, Bis(2-ethylhexyl) phthalate, Butyl benzyl phthalate, Di-N-Butyl Phthalate, Di-n-octyl phthalate, Diethyl Phthalate, Dimethyl phthalate, 1,2-benzanthracene (benzo(a) anthracene, Benzo(a)pyrene (3 ,4-b enzo-pyrene), 3,4-Benzofluoranthene (benzo(b) fluoranthene), 11,12-benzofluoranthene (benzo(b) fluoranthene), Chrysene, Acenaphthylene, Anthracene, 1,12-benzoperylene (benzo(ghi) perylene), Fluorene, Phenanthrene, 1,2,5,6-dibenzanthracene (dibenzo(,h) anthracene), Indeno (,1,2,3-cd) pyrene (2,3-o-pheynylene pyrene), Pyrene, Tetrachloroethylene, Toluene, Trichloroethylene, Vinyl chloride (chloroethylene), Aldrin, Dieldrin, Chlordane (technical mixture and metabolites), 4,4-DDT, 4,4-DDE (p,p-DDX), 4,4-DDD (p,p-TDE), Alpha-endosulfan, Beta-endosulfan, Endosulfan sulfate, Endrin, Endrin aldehyde, Heptachlor, Heptachlor epoxide (BHC-hexachlorocyclohexane), Alpha-BHC, Beta-BHC, Gamma-BHC (lindane), Delta-BHC (PCB-polychlorinated biphenyls), PCB-1242 (Arochlor 1242), PCB-1254 (Arochlor 1254), PCB-1221 (Arochlor 1221), PCB-1232 (Arochlor 1232), PCB-1248 (Arochlor 1248), PCB-1260 (Arochlor 1260), PCB-1016 (Arochlor 1016), Toxaphene, Antimony, Arsenic, Asbestos, Beryllium, Cadmium, Chromium, Copper, Cyanide, Lead, Mercury, Nickel, Selenium, Silver, Thallium, Silver, Zinc and 129 2,3,7,8-tetrachloro-dibenzo-p-dioxin (TCDD).

### ITP Methods

In another embodiment, the leading electrolyte (LE) buffer is chosen such that its ions (cations or anions) have higher effective electrophoretic mobility than the ions of the trailing electrolyte (TE) buffer (effective mobility describes the observable drift velocity of an ion under an electric field and takes into account the ionization state of the ion). In another embodiment, sample ions of intermediate effective mobility race ahead of TE ions but cannot overtake LE ions, and so they focus at the LE-TE interface (hereinafter called the “ITP interface”). In another embodiment, the LE and TE buffers are chosen such that the sample ions have a higher mobility than the TE, but cannot overspeed the LE. In another embodiment, the TE and LE buffers form regions of respectively low and high conductivity, which establish a steep electric field gradient at the ITP interface. In another embodiment, the LE buffer (or LE) has a high ionic strength. In another embodiment, the LE buffer (or LE) has a low ionic strength.

In another embodiment, ITP includes a microchannel connected to two reservoirs and is initially filled with LE solution. In another embodiment, a sample comprising an analyte to be detected is mixed in the trailing electrolyte (TE) reservoir. In another embodiment, a sample comprising an analyte to be detected is mixed in the leading electrolyte (LE) reservoir. In another embodiment, a sample comprising an analyte to be detected is injected between the LE and TE. In another embodiment, an electric field induces the electromigration of all ions in the channel.

In another embodiment, the present invention provides the ITP kit as described herein and specific instructions for performing the method as described herein. In another embodiment, the present invention provides a kit comprising an instruction manual describing the method and/or system disclosed herein. In another embodiment, the present invention provides a kit as described herein further comprising an electrophoresis apparatus. In another embodiment, the present invention provides a kit as described herein further comprising an electrophoresis apparatus that is communicatively coupled to a central processing unit (including but not limited to CPU, microprocessor, ASIC or FPGA) that may operate the electrophoresis apparatus based on a predetermined set of instructions.

In another embodiment, the present invention provides methods, systems and kits that reduce false positive or false negative results. In another embodiment, the present invention provides methods, systems and kits that reduce background noise. In another embodiment, the present invention provides methods, systems and kits that provide accurate quantitative measurements of analtyes of interest. In another embodiment, the present invention provides methods, systems and kits that provide an efficient separating technique for an analyte of interest.

In another embodiment, the present method requires minimal or no sample preparation. In another embodiment, the theory behind ITP is provided in Bahga S S, Kaigala G V, Bercovici M, Santiago J G. High-sensitivity detection using isotachophoresis with variable cross-section geometry. Electrophoresis. 2011 February; 32(5):563-72; Khurana T K, Santiago J G. Sample zone dynamics in peak mode isotachophoresis. Anal Chem. 2008 Aug. 15; 80(16):6300-7; and Isotachophoresis: Theory, Instrumentation and Applications. F. M. Everaerts, J. L. Beckers, T.P.E.M. Verheggen, Elsevier, Sep. 22, 2011, which are hereby incorporated by reference in their entirety.

Automated μPADs

In additional embodiments, said electrokinetic analysis, such as ITP, is automated by virtue of using a flow channel having unique geometrical properties (e.g., narrow constrictions) and measuring changes in the applied electric field. Without wishing to be bound by any theory or mechanism of action, a substantial change in the measured electric current or voltage indicates passage of the ITP interface through a transition region (e.g., transition between a wide and narrow section of the channel), which can respectively be used for performing one or more pre-defined functions on the ITP interface. As a non-limiting example, for a constant applied voltage, the current in ITP decreases monotonically due to increase in resistance. However, a rapid and significant current drop is observed upon entrance of the ITP interface into a constriction. In some embodiments, the significant current drop may be used for performing a pre-determined action, including but not limited to, switching off the electric field. As a non limiting example, arrival of concentrated ITP zone to a desired chamber may result in automatically turning off the electric field allowing the sample to diffuse, thereby enabling increased reaction rates. After a pre-defined time allocated for reaction, the electric field may be reestablished and the ITP interface continues electromigrating, removing any un-reacted species from the surface.

In another embodiment, identification of ITP location triggers or results in performing at least one pre-defined action. In another embodiment, said action performed in response to an electric current/voltage change is modulation of the ITP interface. Non-limiting examples of pre-defined actions, which may be performed in response to an electric current/voltage change as described herein include: substantially modulating the electric field for a pre-determined period of time; applying a counter-flow for a pre-determined period of time; modulating the temperature in a pre-determined zone in said flow channel; adding at least one compound or composition to a pre-determined zone in said flow channel; and operating (e.g., turning on/off) a light source or imaging device; or a combination thereof.

In another embodiment, the action performed in response to an electric current/voltage change is substantially modulating the electric field for a pre-determined period of time. In another embodiment, said modulating is reducing the electric field. In another embodiment, said modulating is switching the electric field off. In another embodiment, said modulating is enhancing the electric field.

In another embodiment, said modulating the electric field is modulating (or switching) the electric field path. In another embodiment, the said flow channel is a branched flow channel. In another embodiment, modulating the electric field path is applying an electric filed in the direction of a branch of the flow channel. In another embodiment, said branch is configured to contain a solution of leading electrolytes (LE). In another embodiment, said branch is configured to contain a solution of trailing electrolytes (TE). In another embodiment, modulating the electric field results in driving (flowing or electromigrating) the analyte to the branched channel. In another embodiment, the apparatus is configured to separate said analyte of interest. In another embodiment, the electric field is switched from a TE containing sample (i.e. a dirty reservoir) to a clean TE reservoir.

In another embodiment, the action performed in response to an electric current/voltage change is applying a counter-flow (e.g., a flow countering the electric field) for a pre-determined period of time. In another embodiment, said applied counter-flow is configured to maintain a non-migrating zone for the analyte (e.g., in the ITP interface). In another embodiment, the ITP apparatus and method of the invention further comprise flow generating means configured to generate flow countering the electromigration of the analyte of interest. In another embodiment, the flow generating means is adjusted to equally counter the flow of the analyte. In another embodiment, the flow generating means is responsible for maintaining a stationary portion (non-migrating zone for the analyte) of the ITP. In another embodiment the sum of ITP electro-migration and counter-flow generated by the flow generating means with respect to analyte within the ITP system as described herein, is substantially zero.

In another embodiment, the flow generating means is electro-osmotic or pressure driven. In another embodiment, the flow generating means is a pump. In another embodiment, the flow generating means is a reciprocating pump. In another embodiment, the flow generating means is a rotary pump. In another embodiment, the flow generating means is a mechanical pump. In another embodiment, the flow generating means is an electroosmotic pump. In another embodiment, the flow generating means is the native electroosmotic flow of the channel. In another embodiment, the flow generating means is any pump known to one of skill in the art. In another embodiment, the flow generating means or pump generates a continuous flow. In another embodiment, the flow generating means or pump generates a uniform outflow. In another embodiment, the flow generating means or pump generates a uniform pressure. In another embodiment, the flow generating means or pump can be adjusted in terms of its pumping capacity, its outflow generation, its pressure generation or any combination thereof.

In another embodiment, said at least one action is modulating (reducing, elevating or maintaining) the temperature in a pre-determined zone in said flow channel. In another embodiment, temperature modulation in a pre-determined zone in said flow channel is useful for enhancing analyte detection reaction. In another embodiment, said analyte is a nucleic acid molecule. As will be appreciated by a skilled artisan, various nucleic acid reactions which require temperature modulation steps (e.g., PCR or hybridization assays) may be used in the ITP apparatus and method described herein. None-limiting methods and devices for controlling temperature include external sources such as a peltier device or external electrodes, embedded heating elements (such as electrodes embedded in the channel), radiation, heating such as by increasing joule heating, and increasing or reducing heat dissipation from the flow channel.

In another embodiment, the action performed in response to an electric current/voltage change is operating a light source or imaging device. Operating, in one embodiment, is turning on the light source or imaging device. In another embodiment, operating is turning off the light source or imaging device. In some embodiments, the light is kept off to prevent photobleaching of a sample, and is turned on when the ITP interface (comprising the sample) approaches the detector. In another embodiment, said pre-determined period of time is of at least 1 second, of at least 5 seconds, of at least 10 seconds, of at least 15 seconds, of at least 20 seconds, of at least 25 seconds, of at least 30 seconds, of at least 40 seconds, of at least 50 seconds or of at least 60 seconds. In another embodiment, said pre-determined period of time is of at most 5 hours, at most 2 hours, at most 1 hour, or at most 0.5 hour. Each possibility represents a separate embodiment of the present invention. It will be apparent to one skilled in the art that the effective pre-determined period of time varies according to the particular function/actions performed in response to an electric current/voltage change, such as, a pre-determined period of time of about 1 second is effective in functions such as modulating the temperature, addition of a compound or operating a light source/imaging device; however, longer periods of time (e.g., of at least 5 seconds) may be required for functions such as electric filed changes.

In some embodiments, the ITP system or kit disclosed herein comprises a (disposable or permanent) ITP apparatus and a measurement apparatus configured to interact with said ITP apparatus, said measurement apparatus comprising a control unit configured to modulate an ITP interface of said ITP apparatus in response to a significant electric current or voltage change. In some embodiments, said measurement apparatus is configured for detection of electric current and/or voltage changes (e.g., a rapid current drop). In some embodiments, said detection is performed using cross-correlation between a step function and the electric current or voltage measurement. The exact shape of the step function may be determined from preliminary experiments performed on the same geometry.

In some embodiments, the ITP apparatus, kit, system and method described herein comprise applying constant voltage and detecting current changes. In other embodiments, the ITP apparatus, kit, system and method described herein comprise applying constant current and detecting voltage changes.

In some embodiments, the correlation between the step function and the electric current/voltage signal is maximal at times where the shape of the current/voltage curve is most similar to step function. Local maxima in the cross-correlation signal may be detected, indicating passage through the constriction. A decision is then made and communicated (e.g. command to the power supply to turn off).

In another embodiment, at least two constrictions are used, wherein the first constriction is used as a learning step to construct the step function, which is then applied for detection of additional constrictions.

In another embodiment, the rate of the current/voltage changes (e.g., current decrease or voltage increase) in a straight channel (e.g. beginning of the channel) together with knowledge of the geometry is used to construct the step function.

In another embodiment, the change in current/voltage rate is detected by continuously calculating the local derivative of the current/voltage with respect to time. In another embodiment, the change in current/voltage rate is detected by continuously fitting a finite length of the electric current/voltage signal with a linear function.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### EXAMPLES

Generally, the nomenclature used herein and the laboratory procedures utilized in the present invention include molecular, biochemical, microbiological and recombinant DNA techniques. Such techniques are thoroughly explained in the literature. See, for example, “Molecular Cloning: A laboratory Manual” Sambrook et al., (1989); “Current Protocols in Molecular Biology” Volumes I-III Ausubel, R. M., ed. (1994); Ausubel et al., “Current Protocols in Molecular Biology”, John Wiley and Sons, Baltimore, Md. (1989); Perbal, “A Practical Guide to Molecular Cloning”, John Wiley & Sons, New York (1988); Watson et al., “Recombinant DNA”, Scientific American Books, New York; Birren et al. (eds) “Genome Analysis: A Laboratory Manual Series”, Vols. 1-4, Cold Spring Harbor Laboratory Press, New York (1998); methodologies as set forth in U.S. Pat. Nos. 4,666,828; 4,683,202; 4,801,531; 5,192,659 and 5,272,057; “Cell Biology: A Laboratory Handbook”, Volumes I-III Cellis, J. E., ed. (1994); “Culture of Animal Cells-A Manual of Basic Technique” by Freshney, Wiley-Liss, N. Y. (1994), Third Edition; “Current Protocols in Immunology” Volumes I-III Coligan J. E., ed. (1994); Stites et al. (eds), “Basic and Clinical Immunology” (8th Edition), Appleton & Lange, Norwalk, Conn. (1994); Mishell and Shiigi (eds), “Strategies for Protein Purification and Characterization-A Laboratory Course Manual” CSHL Press (1996); all of which are incorporated by reference. Other general references are provided throughout this document.

### Example 1

### Joule Heating in Application of Electrokinetic in Paper-Based Devices

In initial attempts to perform ITP on paper, channels which were based on the entire thickness of the filter paper (approximately 150 μm deep) were created. Such designs exhibited high temperatures leading to rapid evaporation of the liquid and occasionally even autoignition of the paper. Thus, better thermal management of paper-based devices was required for electrokinetic applications. Aiming to maintain a simple and low-cost device, which does not require addition of external heat-removing devices. Instead, the potential for a geometrical design that would prevent excessive heating was studied.

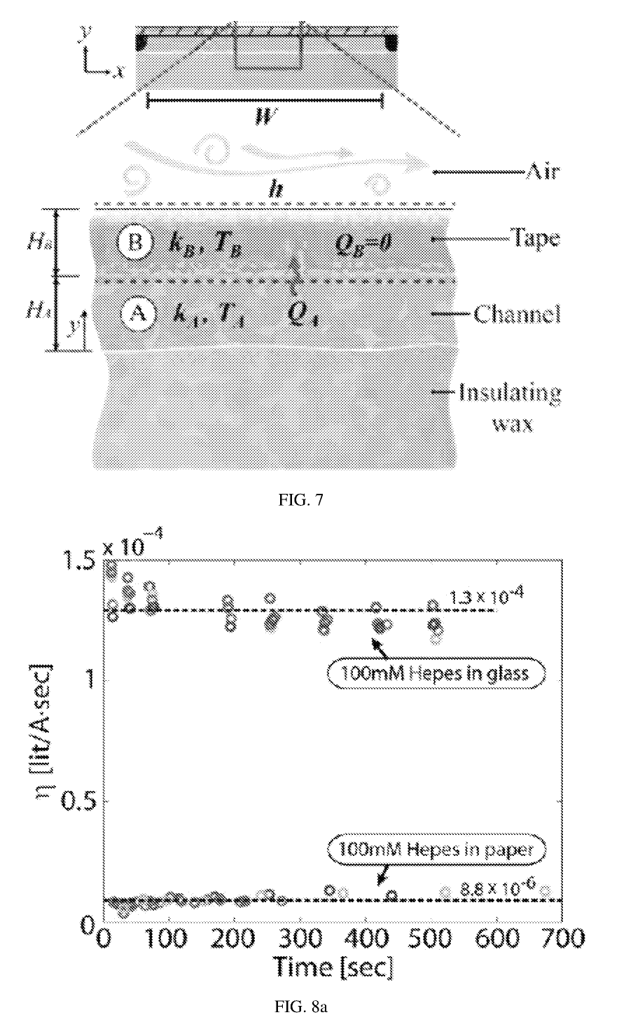

As illustrated in FIG. 7, the inventors consider the cross section of a paper channel sealed from bottom and top by wax and masking tape, respectively. The problem was divided into two different regions; the paper channel is denoted as A, and the sealing material (e.g. masking tape) is marked as B. Moreover, the inventors assume the width of the channel, W (typically on the order of several mm to several cm), is much larger than its depth, _{HA}(typically in the order 10-100 μm), and therefore the problem can be treated as a 1D problem in the y (depth)-direction.

Clearly, the temperature can be most efficiently reduced by lowering the electric field (by decreasing the voltage used). However, this will also result in a diffused ITP interface and an increase in total analysis time. Lower LE concentration (resulting in lower conductivities) could also be used. However, this would also eliminate TE concentration adaptation which is a source of significant increase in focusing rate. Thus, in order to maintain high electric fields in the system, without excessive joule heating, one should reduce the paper channel depth, H_{A}, as much as possible. As described in detail in the Experimental section, reducing the thickness of the paper from 150 μm to the range such as 10-50 μm is sufficient to reduce the temperature to an operational range.

### Example 2

### Fabrication of Shallow Channel μPADs

A low-cost and simple method of fabricating μPADs is wax printing. The technique is based on patterning a hydrophilic paper (or other porous membranes) with hydrophobic wax barriers. Upon heating, the wax melts and penetrates by capillary action through the entire thickness of the paper, and serves as side walls for the paper-channel.

The present invention further developed this technique to be compatible with electrokinetic assays. Instead of printing only one layer of wax that wicks through the entire thickness of the paper, wax is printed on both sides of the paper. Upon heating, both layers wick into the paper until they meet, resulting in channels that are significantly shallower (˜50 μm) than the original thickness of the paper. Such shallow channels are critical in providing sufficient dissipation of joule heat, as detailed above, and thus enable the use of high electric fields and short analysis time.

Cellulose filter paper (125 mm diameter, grade 595, Whatman™, GE) is used as a substrate, as it is relatively thin (150 μm thickness) and provides medium-fast flow rate compared to other filter papers. Cellulose was chosen as a substrate as it does not contain active functional group and thus is expected to have only weak interaction with biomolecules. The paper is cut to fit A6 paper-size width using a guillotine (3020, KW-trio, Changua, Taiwan). The device's geometry was then design in Autodesk AutoCAD 2013 (Autodesk Inc, San Rafael, Calif.), and the microfluidic paper-chip was fabricated by printing (ColorQube 8570DN, Xerox Corporation, Norwalk, Conn.) the channel side walls template on one side of the paper, followed by a layer of wax on the opposite side, forming the bottom of the channel. After printing, the two layers are not yet in contact. In order to create a closed channel, the paper is then heated using a temperature-controlled lamination machine (335 R6, SKYDBS Co., Seoul, Korea), which provides uniform heating and can be controlled to provide penetration of the wax to the desired depth.

Different temperatures provide different channel depths. At low temperatures, less than 75° C., the wax penetration level is insufficient, and the side walls created do not reach the bottom layer of wax. This results in leakage from the channel upon filling. At high temperatures, over 105° C., the bottom layer of wax may penetrate the paper entirely and block the channel. The inventors found the optimal lamination temperature, providing shallow yet unblocked channels, to be 95° C., at a feeding speed of 1350 mm/min. The obtained paper channel depth was measured by cutting the paper using a guillotine in a direction perpendicular to the channel, placing the piece between two glass slides for mechanical stability and imaging the cross section area under the microscope (see FIG. 2). At these conditions, the average depth was estimated to be 50 μm. Finally, in order to prevent evaporation, the channel was covered with a transparent tape (type 8911, 3M, Saint Paul, Minn.), while both reservoirs were kept open to the atmosphere. The nominal paper channel dimensions used for all experiments were 2.6 cm length, 2.5 mm width and 50 μm depth. The channels connect on either end to 6.5 mm radius circular reservoirs. FIG. 2 presents the fabrication process of a non-limiting example of paper-based device, and a 3D view image of the device.

### Example 3

### Isotachophoresis Assay on Paper-Based Devices

Experimental Setup

Images were obtained using an upright epifluorescent microscope (Eclipse Ci-L, Nikon, Tokyo, Japan) equipped with a 660 nm LED light source (M660L3-C3, Thorlabs Inc., Newton, N.J.) and filter-cube (Cy5-4040C-000: 628/40 nm excitation, 692/40 nm emission and 660 nm dichroic mirror, Semrock Inc., Rochester, N.Y.). A 1× objective (NA=0.04, WD=3.2 mm, Plan UW, Nikon, Tokyo, Japan) was used for the experiments in paper devices, and a 10× objective (NA=0.3, WD=16 mm, Plan Fluor, Nikon, Tokyo, Japan) for the experiments in glass channels. Images were captured using a 14 bit, 1392×1040 pixel array CCD camera (Clara DR-2584, Andor, Belfast, Ireland) cooled to −19.5° C. Images of the ITP focusing were taken using an exposure time of 100 ms. When not imaging, the light source was shuttered to prevent photobleaching of the dye. The camera was controlled using NIS Elements software (v.4.11, Nikon, Japan) and processed the images with MATLAB (R2011b, Mathworks, Natick, Mass.). All ITP experiments were performed at constant voltage, using a high voltage sourcemeter (model 2410, Keithley Instruments, Cleveland, Ohio).

In all experiments, 100 mM HCl, 200 mM Bistris, and 1% 1.3 MDa poly(vinylpyrrolidone) (PVP) was used as the LE solution. The analyte was DyLight650 (NHS Ester, Thermo Fisher Scientific, Waltham, Mass.) which has its peak fluorescence at an excitation wavelength of 652 nm. The analyte was mixed with the TE solution to get an initial concentration of 10 nM DyLight650 in the reservoir. Ttwo sets of TE solutions were used; the first TE set was composed of 100 mM Hepes, 200 mM Bistris, and 1% PVP; the second TE set was composed of 10 mM Tricine, 20 mM Bistris, and 1% PVP. The former set was used for the experiments comparing the focusing efficiency of paper devices to glass channels. The latter set was used for demonstration of maximum focusing in paper. PVP was added to the LE and TE solutions for suppression of electroosmotic flow (EOF). High ionic strength LE was used to maximize the focusing rate of species, and to ensure a thin double layer for further reduction in EOF. The TE buffer consisting of 10 mM Tricine provides higher accumulation rates at the expense of lower buffering capacity. Lower concentration could not be used as the assay's repeatability and robustness is compromised. Hepes, Tricine, Bistris, and PVP were obtained from Sigma-Aldrich (St. Louis, Mo.). HCl was obtained from Merck (Darmstadt, Germany). All buffer solutions were made using deionized water (DI) from a Millipore Milli-Q system (Billerica, Mass.).

The experiments in a glass channel were performed on a commercially available isotropically etched microchip (NS12A, PerkinElmer, Waltham, Mass.) having channel dimensions of 90 μm×20 μm (width×depth). The chip consisted of 4 reservoirs connected by channels; the West reservoir was connected to the longest channel (45.59 mm long) which intersected three shorter channels, termed North (15.1 mm long), South (3.92 mm long) and East (7.38 mm long). The channel was first cleaned by flowing 200 mM NaOH for 1 min, followed by 1 M HCl for another 1 min, and then rinsed the channel with DI for 1 min. In each experiment, vacuum was applied to the West reservoir to fill the North, East and South reservoirs with 20 μL of LE. Once the channel was filled, the West reservoir was rinsed with DI water, and filled it with 20 μL of TE-analyte mixture. The positive electrode to the East reservoir, and grounded the West reservoir. A voltage of 400 V was applied across the channel, and simultaneously record the resulting electric current. The focused sample was imaged at eight stations, located 4.7, 9.7, 14.7, 25.7, 30.7, 35.7, 40.7 and 44.7 mm from the TE reservoir. At each station, the images were background corrected (background was taken in the LE solution, before ITP plug arrives).

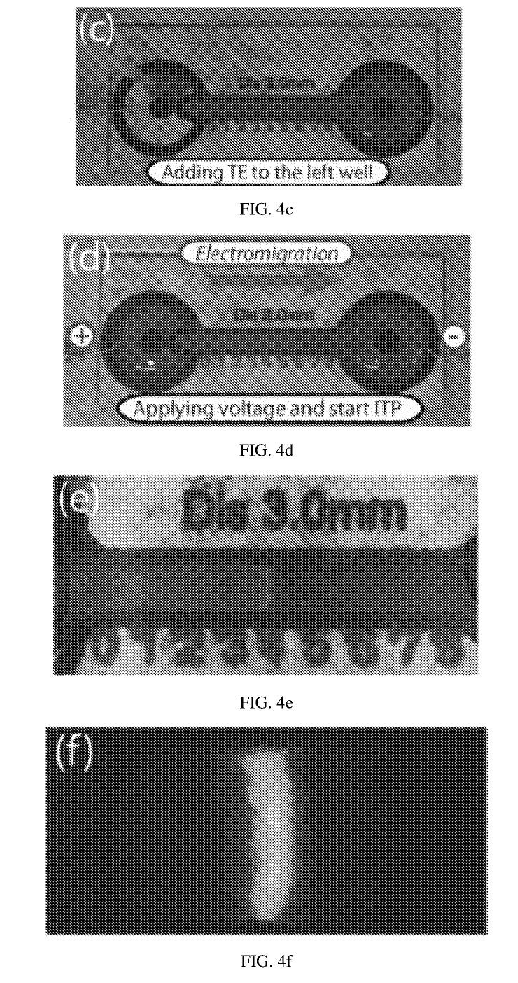

The process of running ITP on the described fabricated μPAD is presented in FIG. 4. For convenience, the process was separated into two steps to allow filling of multiple channels simultaneously. The process began by adding 150 μL of LE to the right reservoir, and relied on capillary action for filling the channel with LE solution (FIG. 4b). Sufficient time (˜10 min) was allowed for the liquid to reach a designed wax barrier, where it stopped (FIG. 4c). The chip was then located on the microscope, placed the electrodes in each of the reservoirs, and added another 150 μL of LE to the right reservoir. The left reservoir was filled with 300 μL of a TE-analyte mixture (FIG. 4c). Importantly, the left-most part of the channel is initially exposed to air (i.e. is not covered by tape), and after adding the buffers serves as the initial contact point of the LE and TE. 200 V was applied across the channel to initiate ITP. FIGS. 4e and 4f respectively present the resulting focused ITP plug, as imaged by a consumer grade camera (SX510 HS, Canon, Tokyo, Japan) and by the microscope. The focused sample was imaged at eight stations, located at 0.75, 1, 1.25, 1.5, 1.75, 2, 2.25 and 2.5 cm from the TE reservoir (stations are printed as 1-8 on the paper-chip in FIG. 4). At each station, the images were background corrected (background was taken in the LE solution, before ITP plug arrives).

To enable processing of large sample volumes, the paper channel was designed to be 2.5 mm wide. Under the applied voltage of 200 V, the electric currents established are on the order 100 to 1,000 μA. Large reservoirs volume are thus required for three primary reasons: (i) provide sufficient hydration for the paper, compensating any residual evaporation; (ii) provide sufficient buffering from electrolysis; and (iii) provide sufficient sample volume to be processed by the ITP channel. The described design supports 300 μL in each of the reservoirs, which as further demonstrated in the experimental results section, provides sufficient sample to maintain a repeatable and stable process for over 10 min.

### Results

As illustrated qualitatively in FIG. 4e, at high initial concentrations (>1 μM) the ITP plug can be seen by naked eye and imaged by consumer-grade camera. However, the quantitative analysis presented in this and subsequent sections utilize significantly lower concentrations and has been performed based on microscope imaging.

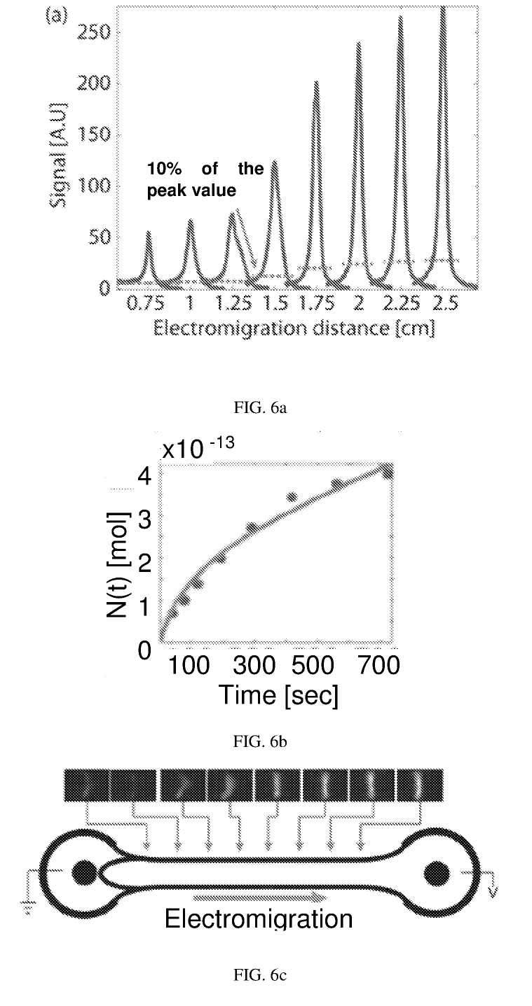

FIG. 6 presents quantitative experimental results of ITP focusing on the μPADs described herein, in a continuous injections scheme (i.e. sample mixed in the TE reservoir). FIG. 6c presents raw fluorescence images of the ITP front at the different stations along the paper channel. While the sample zone appears significantly more dispersed compared to sample focusing observed in standard glass microchannels, focusing is nevertheless clearly evident and the ITP plug is well contained and steadily electromigrates along the paper channel. FIGS. 6a-b present respectively the width averaged concentration along the channel, during ITP, and the total sample accumulation. Each image was converted from intensity values to concentrations through a calibration curve of each substrate, and average those concentrations across the width of channel. The total accumulated sample at each station was calculated by integrating all concentrations greater than 10% of the maximum, and multiplying by the width, depth, and porosity of the channel. FIG. 6b presents the total accumulated sample as a function of time with the solid line. The value obtained in paper is 8.8×10⁻⁶ [lit Λ⁻¹], vs 1.3×10 ⁻⁴ [lit Λ⁻¹sec⁻¹] in glass, indicating only 7% efficiency of paper compared to glass.

### Example 4

### Characterization of ITP Extraction Efficiency on μPAD

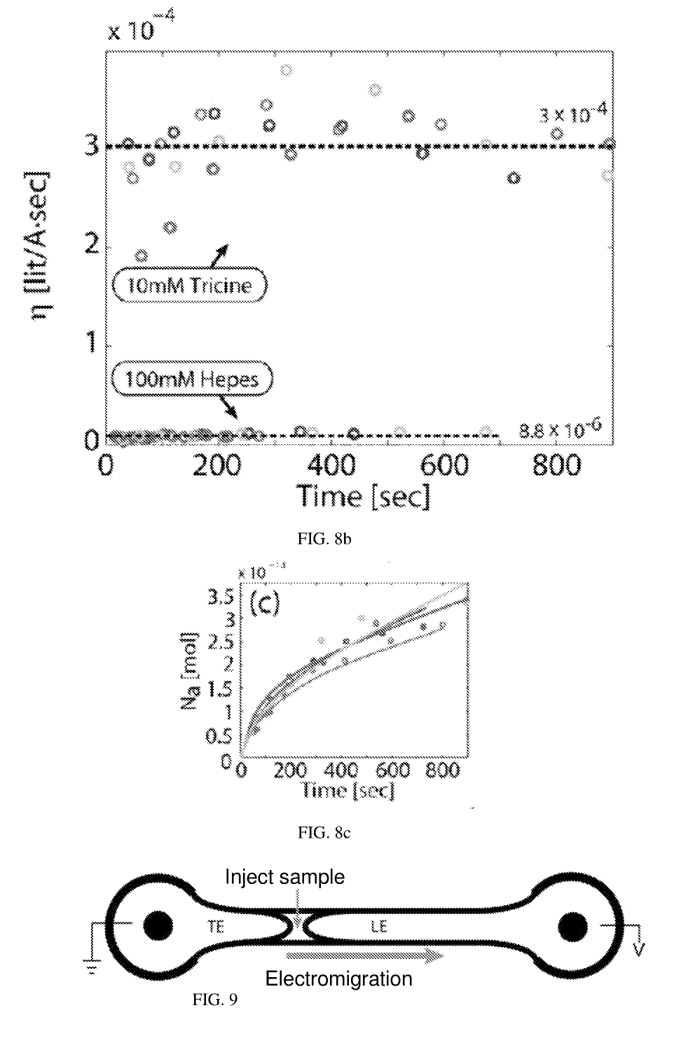

FIG. 8a presents experimental results for this chemistry, showing the value of η (i.e. the ratio of the total accumulated sample to the integral of current and the initial concentration of the analyte in the reservoir) as a function of time for both the glass channel and the paper channels. Importantly, both setups yield a near constant value, consistent with the analytical model. The mean value obtained in the glass channel is 1.3×10⁻⁴ [lit A⁻¹sec⁻¹], which is similar to the numerical prediction. The inventors thus consider the experiments in glass to be the accurate reference value. A similar qualitative behavior was observed in the paper, with a roughly constant value of η obtained indicating that dependence on the integral of current holds equally well here.

### Demonstration of 1,000-Fold Sample Focusing on μPAD

For a given analyte mobility, in order to maximize the amount of sample focused at the ITP interface, minimizing of the TE mobility, as well as reducing the TE concentration is hypothesized to allow a larger increase in analyte concentration across the TE adaptation region. Thus Hepes (pKa 7.5) was replaced by Tricine (pKa 8.15) resulting in an expected reduction in effective TE mobility, and reduce the TE concentration from 100 mM to 10 mM.

FIG. 8b presents the experimentally measured η for the two TE chemistries, showing a 34-fold improvement in sample accumulation with the 10 mM Tricine chemistry. FIG. 8c presents the total accumulated sample (in moles) as registered at each station, using the 10 mM Tricine 20 mM Bistris TE chemistry. The total sample accumulated is approximately 3×10⁻¹³ [mol], which was achieved after 700 sec. Since the initial concentration of the analyte in the TE reservoir is 10 nM, the total sample volume which was processed by ITP, evaluated by

$$\frac{{N}_{a} ( t )}{{c}_{0}} ,$$

### is 30 μL.

Thus far, the results addressed the total amount of sample accumulated at the ITP interface. FIG. 6a-c provides a quantitative evaluation of peak (maximum) and average concentration of the focused sample. Peak value is important for detection and imaging applications where focusing is used to directly increase the signal to be detected (e.g. of a fluorescent molecule). However, in application where ITP is used to accelerate the reaction between co-focusing species, it is the average concentration which, to first order approximation, determines the rate of reaction.

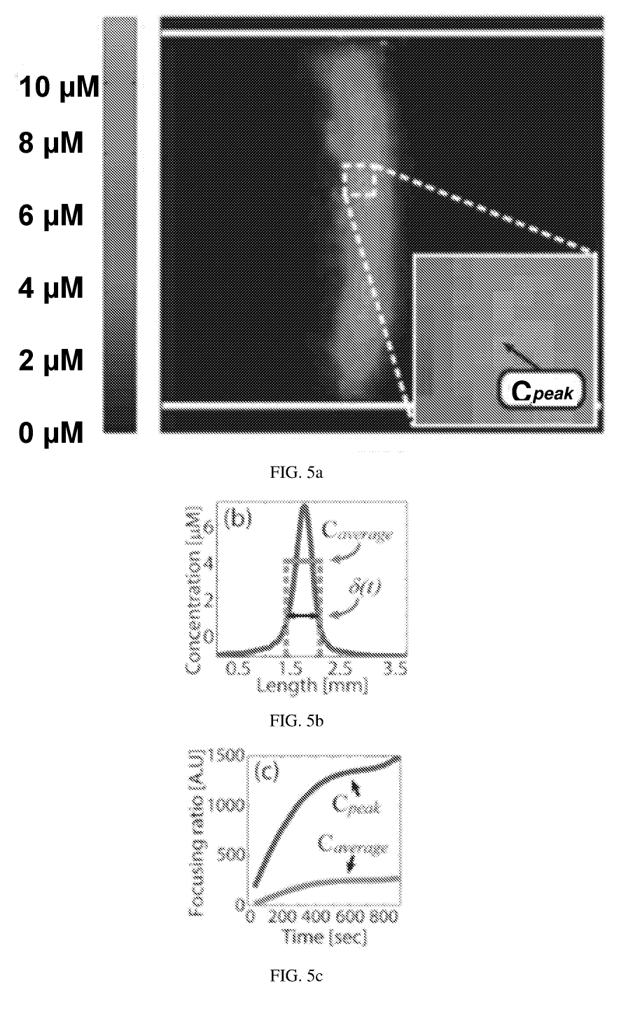

FIG. 5a presents a typical raw fluorescence image of the focused sample. At each station, to reduce noise associated with this measurement, the inventors applied 5×5 binning to the ITP plug image and convert it to concentrations via the calibration curve. We find the peak concentration by picking the highest value in the resulting image. FIG. 5b presents the width averaged concentration at each station. We find the averaged concentration by averaging all concentrations greater than 10% of the maximum. FIG. 5c presents the peak and average focusing ratios as a function of time.

Results show that over a 5 min duration, paper-based ITP provides average concentration enhancement of 200-fold, while the peak concentration is increased by 1,000-fold.

### Example 5

### Demonstration of ITP Focusing of HRP-2 on Paper and In a Glass Microchannel

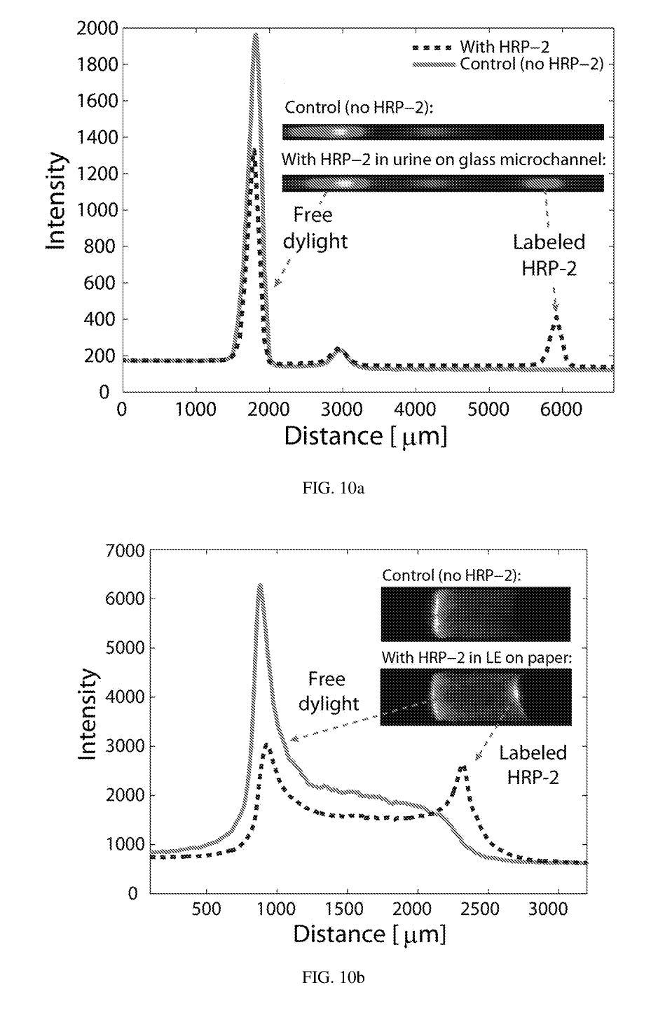

FIG. 10a demonstrates ITP focusing of HRP-2 from a spiked urine sample, in a glass microchannel. For visualization purposes, HRP-2 was labeled with Dylight 650, resulting in HRP2-dye hybrids and free excess dye. As a control, the same experiment was performed without the HRP-2. The curves show the averaged fluorescence intensities for both experiments, and the insets show raw fluorescence images of these experiments. Results clearly show the focusing of the HRP-2 antigen, as well as the ability to separate it from other species (in this case free dye). TE was composed of 20 mM Bistris, 10 mM Hepes, 100 μM MES; LE was composed of urine, with an adjusted pH of 6.8, including the spiked sample. FIG. 10b demonstrates ITP focusing of HRP-2 spiked in LE solution on paper. Curves correspond to width averaged fluorescent intensities of the raw fluorescence images presented in the inset. The ability to focus HRP-2 and to find appropriate spacers which separate and isolate it from other species is shown. TE was composed of 20 mM Bistris, 10 mM Hepes, 500 μM MES; LE was composed of 200 mM Bistris, 100 mM HCl and includes the spiked sample.

### Discussion

The present experimental and analytical study shows a novel paper-based analytical device for sample focusing using isotachophoresis. It is exemplified herein that although dispersion is much more significant in paper than in glass, substantial sample focusing (on the order of 1,000-fold) can be achieved in several minutes. Obtaining high sample concentrations in paper has direct implications in accelerating reaction kinetics and creating low-cost devices with much enhanced sensitivity.

Another benefit of paper-based ITP is the ability to process large sample volumes. While microchannles are an excellent platform for ITP, their small dimensions typically limit their application to the analysis or processing of small sample volumes. Implementation of ITP in larger channels or larger diameter capillaries is challenging due to hydrodynamic instabilities and excessive joule heating. Paper (and porous media in general) offers the ability to reach large sample volumes while maintaining high hydrodynamic resistance in a planar format. In the work presented herein, 2.5 mm wide channels were used and demonstrated processing of 30 μL of sample in several minutes. However, no fundamental reason is seen why the width of the channel could not be substantially increased to enable processing of hundreds of μL and even mL. This would open the door to the use of ITP for detection of extremely dilute samples (e.g. detection of bacteria at 10-100 copies per mL).

Managing joule heat and limiting evaporation are key challenges in integrating electrophoretic techniques with paper-based devices. While many other techniques for fabrication of paper-based devices exist, it is demonstrated herein that wax printing is particularly suitable for obtaining shallow channels which result in higher surface to volume ratio of the channels and thus faster dissipation of the heat. Nevertheless, one could envision other methods for achieving this goal, with the most simple being the use of paper sheets of smaller initial thickness.

The results show that the device disclosed herein serves as a low-cost, rapid and highly sensitive paper-based diagnostic platform.

1-39. (canceled)

40. A micro-fluidic electrokinetic apparatus comprising a substrate comprising a porous hydrophilic region bounded by a fluid-impermeable barrier, said porous hydrophilic region comprising:
(a) a first zone configured to contain a first solution and a second zone configured to contain a second solution, said first zone and said second zone are configured to be operably connected to at least one anode and at least one cathode; and
(b) at least one flow channel elongated between said first zone and second zone, wherein a substantial portion of said at least one flow channel has a depth of at most 100 μm.

41. The apparatus of claim 40, further comprising any one of:
(c) at least one hydrophobic barrier disposed on said at least one flow channel and configured to define a contact region between a first solution and a second solution;
(d) a covering over a substantial portion of said at least one flow channel; and
(e) at least one probe configured to react with a molecule of interest.

42. The apparatus of claim 41, wherein said at least one hydrophobic barrier is selected from the group consisting of:
a hydrophobic barrier disposed on said at least one flow channel is configured to serve as an electrokinetic repeatable interface;
a hydrophobic barrier disposed on said at least one flow channel is configured to suspend fluidic flow until injection of a first and a second solution to said first and second zones;
a hydrophobic barrier disposed on said at least one flow channel comprises two hydrophobic barriers forming a sample injection zone configured to suspend fluidic flow until injection of a sample to said sample injection zone;
a hydrophobic barrier being an isotachophoresis (ITP) starting point.

43. The apparatus of claim 40, wherein said electrokinetic is isotachophoresis (ITP), said first solution is a solution of high effective mobility leading electrolyte (LE) ion, and said second solution is a solution of low effective mobility trailing electrolyte (TE) ion.

44. The apparatus of claim 40, wherein said fluid-impermeable barrier substantially permeates the thickness of the substrate, thereby bounding said hydrophilic region therewithin.

45. The apparatus of claim 40, wherein said substrate comprises at least one layer comprising said hydrophilic region and at least one hydrophobic layer.

46. The apparatus of claim 40, wherein said at least one hydrophobic layer is disposed beneath and in contact with said at least one layer comprising said hydrophilic region.

47. The apparatus of claim 40, wherein said porous hydrophilic substrate is selected from a porous hydrophilic substrate comprising cellulose, cellulose acetate, nitrocellulose, polyester, glass or a combination thereof and a porous hydrophilic substrate selected from chromatography paper, filter paper, blotting membrane, or lateral flow membrane.

48. The apparatus of claim 41, wherein said covering is selected from:
an electrical conductivity selected from a substantially low electrical conductivity and a substantially high thermal conductivity;
a transparent covering; and
adhesive tape.

49. The apparatus of claim 41, wherein said at least one probe is selected from a probe immobilized to a surface of said at least one flow channel and a probe configured to provide a detectable signal upon reaction with a molecule of interest.

50. A method for detecting or separating a molecule of interest, comprising the steps of:
(a) providing the micro-fluidic electrokinetic apparatus of claim 40;
(b) injecting to said apparatus a first solution, a second solution and a sample suspected of comprising a molecule of interest;
(c) initiating electrokinetic flow;
thereby detecting or separating the molecule of interest.

51. The method of claim 50, wherein said apparatus further comprises at least one hydrophobic barrier disposed on said at least one flow channel and configured to define a contact region between a first solution and a second solution, and wherein said initiating electrokinetic flow is automatically initiating electrokinetic flow by said injection of step (b).

52. The method of claim 50, wherein any one of:
said first solution is a solution of high effective mobility leading electrolyte (LE) ion, and said second solution is a solution of low effective mobility trailing electrolyte (TE) ion, and
(ii) the molecule of interest is selected from the group consisting of: a chemical substance, a polynucleotide, a peptide or a polypeptide.

53. The method of claim 50, wherein said injection is finite injection.

54. The method of claim 51, wherein said at least one hydrophobic barrier disposed on said at least one flow channel of said apparatus comprises two hydrophobic barriers forming a continuous sample injection zone, and wherein said injection is continuous injection to said continuous sample injection zone.

55. A kit for detecting and/or selecting a molecule of interest, the kit comprising:
(i) the micro-fluidic electrokinetic apparatus of claim 40;
(ii) a solution of high effective mobility leading electrolyte (LE) ion; and
(iii) a solution of low effective mobility trailing electrolyte (TE) ion
wherein the LE and TE solutions have respectively higher and lower electrophoretic mobility than the molecule of interest.

56. The kit of claim 55, further comprising at least one of: instruction for use of said kit and a detector for detecting a molecule of interest.

57. A process for preparing a micro-fluidic electrokinetic apparatus, the method comprising:
disposing a hydrophobic material onto a substrate in a predetermined pattern to define at least one hydrophilic region therewithin, said predetermined pattern comprising:
(a) a first zone configured to contain a first solution and a second zone configured to contain a second solution;
(b) at least one flow channel elongated between said first zone and second zone; and
(c) at least one hydrophobic barrier disposed on said at least one flow channel;
(ii) heating the substrate and hydrophobic material disposed on said substrate to a temperature sufficient to melt the hydrophobic material, the melted hydrophobic material substantially permeating the thickness of said substrate and defining a pattern of at least one hydrophilic region.

58. The process of claim 57, further comprising disposing a layer of a second hydrophobic material on an opposite side of said substrate, wherein said heating of step (c) is sufficient to melt the second hydrophobic material to substantially permeate the thickness of said substrate, optionally wherein said hydrophobic material and said layer of second hydrophobic material form a hydrophilic region comprising at least one flow channel having a depth of at most 100 μm.

59. The process of claim 57, wherein said heating is in the range of 60° C.-120° C.
